(19) United States
(12) Patent Application Publication
(10) Pub. No.: US 2012/0322382 A1
(43) Pub. Date: Dec. 20, 2012

(54) PORTABLE WIRELESS TERMINAL, WIRELESS TERMINAL DEVICE, AND WIRELESS COMMUNICATION SYSTEM

(75) Inventor: Kiyoshi Toyoda, Tokyo (JP)

(73) Assignee: OLYMPUS CORPORATION, Tokyo (JP)

(21) Appl. No.: 13/592,773

(22) Filed: Aug. 23, 2012

Related U.S. Application Data
(63) Continuation of application No. PCT/JP2011/054308, filed on Feb. 25, 2011.

(30) Foreign Application Priority Data
Feb. 25, 2010 (JP) 2010-040096

(51) Int. Cl. H04B 7/00

(52) U.S. Cl. 455/41.2

(57) ABSTRACT

A battery accumulates electric power. A terminal high-speed wireless communication portion wirelessly communicates information. A terminal communication setting portion sets predetermined setting information related to wireless communication by the terminal high-speed wireless communication portion. A coil antenna is an antenna that receives electric power for recharging the battery in a contactless manner from an external terminal, the coil antenna transmitting or receiving the setting information to or from the external terminal.

### BACKGROUND OF THE INVENTION

1. Field of the Invention

The present invention relates to a portable wireless terminal, a wireless terminal device, and a wireless communication system. This application is a continuation application based on a PCT Patent Application No. PCT/JP2011/054308, filed Feb. 25, 2011, whose priority is claimed on Japanese Patent Application No. 2010-40096, filed Feb. 25, 2010. The contents of both the PCT Application and the Japanese Application are incorporated herein by reference.

2. Description of Related Art

In recent years, spread and development of wireless communication techniques such as wireless LAN (Local Area Network) allow transceivers to be provided with a wireless communication function at a low cost. As a result, pairs of transceivers are more often introduced to households and corporate facilities, and communication settings are made for the transceivers to conduct wireless communication (for example, settings of ID (identification data) and exchange of encryption keys). Furthermore, transceivers are required to further include an application such as frequently changing targets of wireless communication.

In the case of using transceivers wirelessly as described above, it is necessary to drive the transceivers by use of a battery in order to enjoy the merit of not using cables. As the battery, a secondary battery reusable by recharging such as a Ni—Cd (nickel cadmium) battery or a lithium battery is more often used. As a system of recharging the secondary battery, a recharging system utilizing contactless power transmission is established, which utilizes electromagnetic induction or the like to eliminate the need for electric contact. Such a recharging system utilizing contactless power transmission has come into wide use mainly for the products used in damp or wet locations where it is not favorable to use electric contacts. In addition, as an applied technique of contactless power transmission, there is disclosed a technique of superimposing data transmission signals on a contactless power transmission channel (for example, see Japanese Unexamined Patent Application, First Publication No. 2007-143116).

### SUMMARY OF THE INVENTION

According to a first aspect of the present invention, a portable wireless terminal, includes: a battery portion that accumulates electric power; a terminal wireless data communication portion that wirelessly communicates information; a terminal communication setting portion that sets predetermined setting information related to wireless communication by the terminal wireless data communication portion; and a power reception antenna that receives electric power for recharging the battery portion in a contactless manner from an external terminal, the power reception antenna transmitting or receiving the setting information to or from the external terminal.

Preferably, the power reception antenna transmits or receives, as the setting information, information necessary at a beginning of the wireless communication by the terminal wireless data communication portion.

Preferably, the setting information be a user identification data or encryption data for the wireless communication.

Preferably, the power reception antenna transmits or receives the setting information during the recharging or the electric power reception.

According to a second aspect of the present invention, a portable terminal device includes: a wireless data communication portion that wirelessly communicates information; a communication setting portion that sets predetermined setting information related to wireless communication by the wireless data communication portion; and a power transmission antenna that transmits electric power in a contactless manner to an external terminal, the power transmission antenna transmitting or receiving the setting information to or from the external terminal.

Preferably, the power transmission antenna and the wireless data communication portion be arranged in separate housings.

According to a third aspect of the present invention, a wireless communication system includes: a portable wireless terminal and a wireless terminal device, wherein the portable wireless terminal includes: a battery portion that accumulates electric power; a terminal wireless data communication portion that wirelessly communicates information; a terminal communication setting portion that sets predetermined setting information related to wireless communication by the terminal wireless data communication portion; and a power reception antenna that receives electric power for recharging the battery portion in a contactless manner from the wireless terminal device, the power reception antenna transmitting or receiving the setting information to or from the wireless terminal device, and wherein the wireless terminal device includes: a wireless data communication portion that wirelessly communicates information; a communication setting portion that sets predetermined setting information related to wireless communication by the wireless data communication portion; and a power transmission antenna that transmits electric power in a contactless manner to the portable wireless terminal, the power transmission antenna transmitting or receiving the setting information to or from the portable wireless terminal.

Preferably, the terminal communication setting portion limit the wireless terminal device with which the terminal wireless data communication portion wirelessly communicates with the wireless terminal device to or from which the power reception antenna transmits or receives the setting information.

Preferably, the communication setting portion limit the portable wireless terminal with which the wireless data communication portion wirelessly communicates with the portable wireless terminal to or from which the power transmission antenna transmits or receives the setting information.

Preferably, a coverage distance of a wireless communication line between the power transmission antenna and the power reception antenna be substantially equal to a distance that electric power is allowed to be transmitted in the contactless manner.

### BRIEF DESCRIPTION OF THE DRAWINGS

FIG. 1 is a block diagram showing a schematic configuration of a wireless communication system according to a first embodiment of the present invention.

FIG. 2 is a schematic diagram showing a group to which a wireless terminal device and a portable wireless terminal included in the wireless communication system according to the first embodiment of the present invention belongs.

FIG. 3 is a schematic diagram showing a wireless terminal device and a portable wireless terminal included in a wireless communication system according to a second embodiment of the present invention.

### DETAILED DESCRIPTION OF THE INVENTION

### First Embodiment

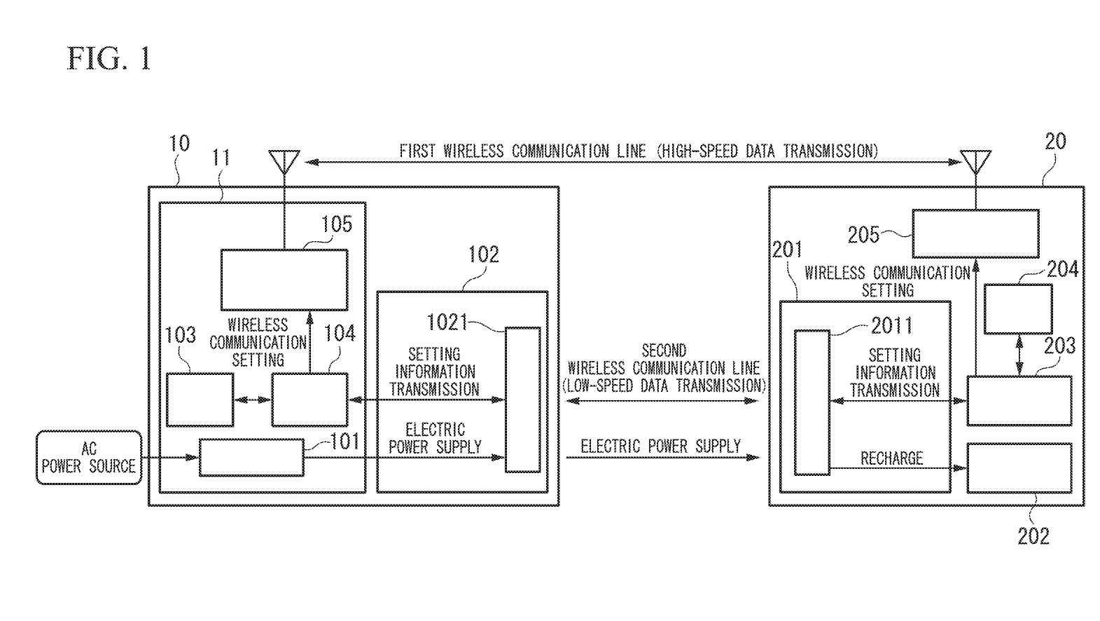

Hereunder is a description of a first embodiment of the present invention with reference to the drawings. FIG. 1 is a block diagram showing a schematic configuration of a wireless communication system of the present embodiment. The wireless communication system includes: a wireless terminal device 10; and a portable wireless terminal 20.

The wireless terminal device 10 includes: a main unit portion 11; and a contactless power transmission portion 102. The main unit portion 11 includes: a power source portion 101; a storage portion 103; a communication setting portion 104; and a high-speed wireless communication portion 105 (wireless data communication portion). The contactless power transmission portion 102 includes a coil antenna 1021 (power transmission antenna). The portable wireless terminal 20 includes: a contactless power reception portion 201; a battery 202; a terminal communication setting portion 203; a terminal storage portion 204; and a terminal high-speed wireless communication portion 205 (terminal wireless data communication portion). The contactless power reception portion 201 includes a coil antenna 2011 (power reception antenna).

The power source portion 101 is connected to a commercial AC power source. The power source portion 101 supplies the electric power, which is supplied from the commercial power source, to the portions included in the wireless terminal device 10. The contactless power transmission portion 102 modifies the electric power, which is supplied from the power source portion 101, so as to be efficiently received by the contactless power reception portion 201 of the portable wireless terminal 20, and transmits the modified electric power via the coil antenna 1021. Furthermore, the contactless power transmission portion 102 uses a second wireless communication line to communicate with the contactless power reception portion 201 of the portable wireless terminal 20 via the coil antenna 1021. The second wireless communication line will be described in detail later.

The storage portion 103 stores information necessary for conducting communication by use of a first wireless communication line. The first wireless communication line will be described in detail later. The communication setting portion 104 makes communication settings of the first wireless communication line. The high-speed wireless communication portion 105 uses the first wireless communication line to communicate with the terminal high-speed wireless communication portion 205 of the portable wireless terminal 20.

The contactless power reception portion 201 converts the electric power, which has been received from the contactless power transmission portion 102 via the coil antenna 2011, to direct-current electric power to recharge the battery 202. In addition, the contactless power reception portion 201 uses the second wireless communication line to communicate with the contactless power transmission portion 102 of the wireless terminal device 10 via the coil antenna 2011.

The battery 202 is a secondary battery, which supplies electric power to the portions included in the portable wireless terminal 20. The terminal communication setting portion 203 makes communication settings of the first wireless communication line. The terminal storage portion 204 stores information necessary for conducting communication by use of the first wireless communication line. The terminal high-speed wireless communication portion 205 uses the first wireless communication line to communicate with the high-speed wireless communication portion 105 of the wireless terminal device 10.

In the illustration, the main unit portion 11 and the contactless power transmission portion 102 are in separate housings by way of representative example. However, they may be integrated. In addition, the contactless power transmission portion 102 preferably has a shape of a cradle where, when the portable wireless terminal 20 is placed on the contactless power transmission portion 102, the coil antenna 1021 of the contactless power transmission portion 102 and the coil antenna 2011 of the contactless power reception portion 201 are set in a positional relationship favorable for contactless power transmission.

Furthermore, for example, the wireless terminal device 10 is supposed to have a well-developed GUI (Graphical User Interface) as is the case with personal computers. The portable wireless terminal 20 is supposed to have difficulty inputting letters and characters as is the case with digital cameras. The case where the personal computer communicates with the digital camera is a known case.

Next, the first wireless communication line will be described. The first wireless communication line is a high-speed data communication line represented by a wireless LAN standardized as IEEE 802.11a/b/g or the like. The high-speed wireless communication portion 105 of the wireless terminal device 10 and the terminal high-speed wireless communication portion 205 of the portable wireless terminal 20 use the first wireless communication line to communicate with each other. The first wireless communication line typically has a coverage distance of several meters to tens of meters. Within that range, the first wireless communication line enables data exchange at high speeds. The first wireless communication line is not limited to one on a standardized communication system but may be one on an original wireless system.

When the high-speed wireless communication portion 105 of the wireless terminal device 10 and the terminal high-speed wireless communication portion 205 of the portable wireless terminal 20 use the first wireless communication line to communicate with each other, it is necessary for the communication setting portion 104 and the terminal communication setting portion 203 to make communication settings by exchanging information such as a group ID or a encryption key. The communication settings include a setting such as specifying a communication target. They are typical settings necessary for conducting communication by use of a wireless LAN or the like. The group ID is a piece of information that is capable of uniquely specifying a group to which the wireless terminal device 10 and the portable wireless terminal 20 belong.

Next, the second wireless communication line will be described. The second wireless communication line is a wireless communication line for which a technique of superimposing data transmission signals on a contactless power transmission channel is used. Therefore, the coil antenna 2011 of the contactless power reception portion 201 is capable of transmitting or receiving the setting information while receiving the electric power from the coil antenna 1021 of the contactless power transmission portion 102 or recharging the battery 202. The distance within which the second wireless communication line can communicate (the distance that the data signal can reach) is substantially the same as the distance that the electric power can be transmitted in a contactless manner.

When communication is conducted between communication instruments by use of a wireless communication line for which the technique of superimposing data transmission signals on a contactless power transmission channel is used, it is difficult for outsiders to intercept the communication because the data transmission distance is short. Therefore, the communication offers high data confidentiality. Furthermore, it is possible to transmit/receive data without making communication settings such as a setting of communication targets. Therefore, if the contactless power transmission portion 102 of the wireless terminal device 10 and the contactless power reception portion 201 of the portable wireless terminal 20 are closer than the transmission distance of the second wireless communication line, it is possible to conduct communication by use of the second wireless communication line without making communication settings.

The frequency used as a carrier frequency for the data transmission by use of the second wireless communication line is lower than that used as a carrier frequency for the high-speed data transmission in recent years (several hundred MHz or higher). Therefore, the second wireless communication line has a low data transmission rate. Furthermore, because the transmission distance of the second wireless communication line is more favorable as it is shorter in view of keeping the data confidentiality, it is preferable to determine the transmission distance based on a tradeoff between usability and distance. In the present embodiment, the contactless power transmission portion 102 of the wireless terminal device 10 and the contactless power reception portion 201 of the portable wireless terminal 20 use the second wireless communication line to transmit/receive information, such as an ID and encryption key, which is necessary for conducting communication by use of the first wireless communication line.

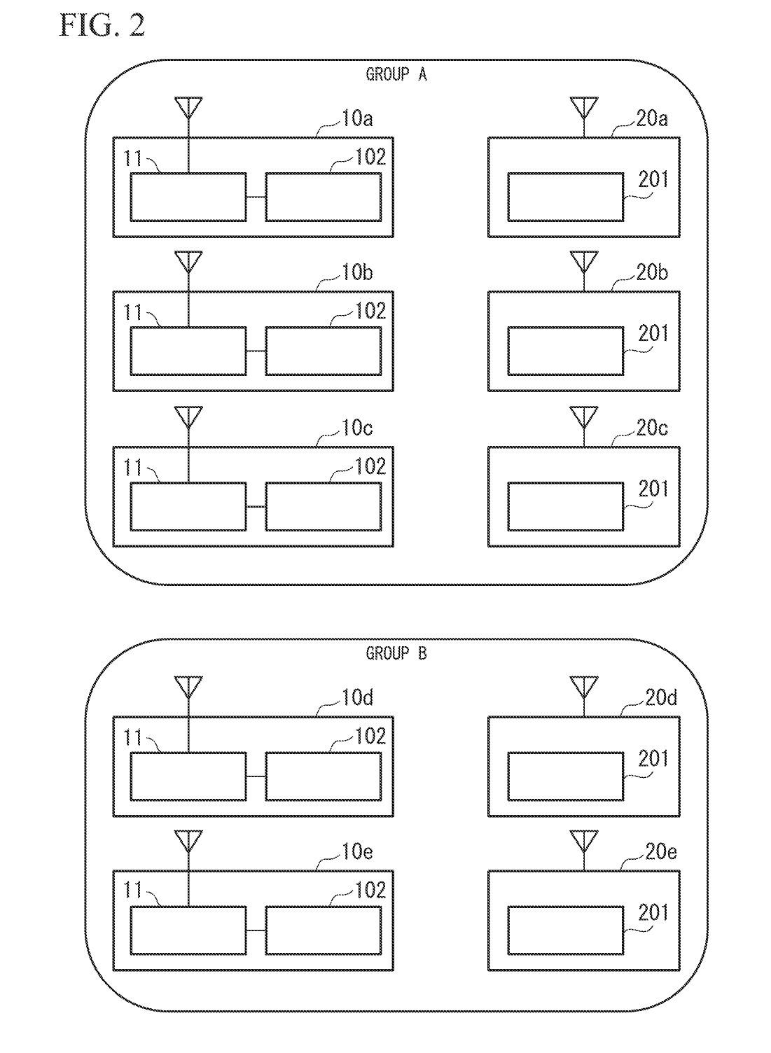

Next, the workings of the present embodiment related especially to the operations of the communication setting portion 104 of the wireless terminal device 10 and the terminal communication setting portion 203 of the portable wireless terminal 20 will be described with reference to FIG. 2. FIG. 2 is a schematic diagram showing a group to which the wireless terminal device 10 and the portable wireless terminal 20 included in the wireless communication system of the present embodiment belong.

In the illustration, wireless terminal devices 10a to 10e and portable wireless terminals 20a to 20e are included in the wireless communication system. The wireless terminal devices 10a to 10c and the portable wireless terminals 20a to 20c belong to a group A. The wireless terminal devices 10d, 10e and the portable wireless terminals 20d, 20e belong to a group B. Furthermore, for a reason such that the group A and the group B have a different possessor, it is assumed to be necessary that, while the wireless terminal devices 10 and the portable wireless terminals 20 belonging to the same group are set so as to be allowed to communicate with each other, the wireless terminal devices 10a to 10c belonging to the group A and the portable wireless terminals 20d, 20e belonging to the group B be set so as not to be allowed to communicate with each other. Furthermore, it is assumed to be necessary that the wireless terminal devices 10d, 10e belonging to the group B and the portable wireless terminals 20a to 20c belonging to the group A be set so as not to be allowed to communicate with each other.

For example, the system of communication setting for the high-speed wireless communication portion 105 of the wireless terminal device 10 and the terminal high-speed wireless communication portion 205 of the portable wireless terminal 20 to communicate with each other by use of the first wireless communication line is assumed to be a system in which the wireless terminal devices 10a to 10c and the portable wireless terminals 20a to 20c belonging to the group A, and the wireless terminal devices 10d, 10e and the portable wireless terminals 20d, 20e belonging to the group B are not allowed to communicate with each other unless they have a group ID and a encryption key that are common in each group.

Next is a description of a method of communication setting that allows the high-speed wireless communication portion 105 of the wireless terminal device 10 and the terminal high-speed wireless communication portion 205 of the portable wireless terminal 20 to communicate with each other by use of the first wireless communication line in the present embodiment. This communication setting is made by the communication setting portion 104 of the wireless terminal device 10 and the terminal communication setting portion 203 of the portable wireless terminal 20.

In the present embodiment, the group ID and the encryption key that are previously stored in the storage portion 103 of the wireless terminal device 10 are transmitted to the portable wireless terminal 20 by the communication setting portion 104 by use of the second wireless communication line. It is assumed that a group ID and a encryption key are input to the wireless terminal device 10 by a known method and that the group ID and the encryption key having been input are stored in the storage portion 103. A simple method of inputting a group ID and a encryption key to the wireless terminal device 10 is a method in which the operator utilizes a keyboard, a mouse, or the like provided to the wireless terminal device 10 to input the optionally-determined group ID and encryption key.

A procedure of transmitting the group ID and the encryption key from the wireless terminal device 10 to the portable wireless terminal 20 by use of the second wireless communication line is as follows. The operator brings the contactless power reception portion 201 of the wireless terminal device 10 close to the contactless power transmission portion 102 of the wireless terminal device 10. When the contactless power transmission portion 102 and the contactless power reception portion 201 are brought closer than the transmission distance of the second wireless communication line, to thereby become capable of communicating with each other by use of the second wireless communication line, then the communication setting portion 104 transmits the group ID and encryption key previously stored in the storage portion 103 to the contactless power reception portion 201 via the contactless power transmission portion 102.

The contactless power reception portion 201 receives the transmitted group ID and encryption key, and inputs them to the terminal communication setting portion 203. Based on the group ID and encryption key that have been input, the terminal communication setting portion 203 makes communication settings of the first wireless communication line, and causes the terminal storage portion 204 to store the group ID and encryption key. With these communication settings, the wireless terminal device 10 and the portable wireless terminal 20 that store the same group ID and encryption key are allowed to communicate with each other by use of the first wireless communication line.

Therefore, the operator is capable of exchanging the group ID and encryption key between the wireless terminal device 10 and the portable wireless terminal 20 only by bringing the contactless power reception portion 201 of the portable wireless terminal 20 close to the contactless power transmission portion 102 of the wireless terminal device 10 such as when recharging by typical contactless power transmission. Furthermore, even if the GUI of the portable wireless terminal 20 is not sufficient, the operator is capable of inputting a group ID and a encryption key to the portable wireless terminal 20 in a very simplified manner.

In the case where the wireless terminal devices 10a to 10e and the portable wireless terminals 20a to 20e belong to the group A or the group B as shown in FIG. 2, the operator is capable of exchanging the group ID and encryption key between a wireless terminal device 10 and a portable wireless terminal 20 that belong to the same group only by bringing the contactless power reception portion 201 of the portable wireless terminal 20 close to the contactless power transmission portion 102 of the wireless terminal device 10. Therefore, the operator is capable of making settings with ease so that only the wireless terminal devices 10 and portable wireless terminals 20 that belong to the same group are allowed to communicate with each other.

The problem about data confidentiality of the group ID and encryption key can be solved by the fact that the communication distance of the second wireless communication line is short. That is, because the communication distance of the second wireless communication line is short, it is easy to prevent outsiders with malicious intent from coming close to the contactless power transmission portion 102 of the wireless terminal device 10. Accordingly, by preventing the outsiders who from coming close to the contactless power transmission portion 102, the outsiders is not capable of transmitting the group ID and the encryption key to the portable wireless terminal 20, thereby the data confidentiality of the group ID and the encryption key is protected. Furthermore, if a verification screen for transferring the group ID and the encryption key is provided in the wireless terminal device 10 and an input of a password or the like is prompted, then the confidentiality can be further enhanced.

In the present embodiment, communication among all the instruments belonging to the same group is always available. Therefore, the source and target of the data transmission by use of the first wireless communication line are required to be specified for every session of the data transmission. However, the above problem is not important if the specification is made with a wireless terminal device 10 with a well-developed GUI.

In the above description, the group ID and encryption key are exchanged by use of the second wireless communication line. However, the information transmitted/received by use of the second wireless communication line is not limited to this. The information such as for enhancing the data confidentiality may be transmitted by use of the second wireless communication line.

Furthermore, the transmission of the main information transmitted/received by use of the first wireless communication line (for example, images, voices, texts, application files, or the like) is limited within a group. However, this does not deny any communication at all with another group. Controlling communication such as for avoiding collision is also conducted with instruments belonging to another group.

As described above, the wireless terminal device 10 and the portable wireless terminal 20 use the second wireless communication line to exchange the group ID and encryption key, to thereby make communication settings of the first wireless communication line. This makes feasible the settings of the first wireless communication without troublesome input of communication setting information. Furthermore, the second wireless communication line is a wireless communication line for which the technique of superimposing data transmission signals on a contactless power transmission channel is used. Therefore, it is possible to make communication settings of the first wireless communication line without the necessity of installing individual antennae for close proximity wireless transmission in the wireless terminal device 10 and the portable wireless terminal 20. This makes a reduction in manufacturing costs and a downsizing of the products possible.

### Second Embodiment

Hereunder is a description of a second embodiment of the present invention. The wireless terminal device 10 and the portable wireless terminal 20 of the present embodiment have similar configurations to those of the first embodiment. In the present embodiment, transmission targets of the main information via the first wireless communication line are limited to one of the wireless terminal devices 10 and one of the portable wireless terminals 20. That is, an example effective for the case of communication typically called P2P (Peer to Peer) will be described.

To be more specific, the portable wireless terminal 20 includes a CCD (Charge Coupled Device) sensor. It is an image transmission device that transmits a picked-up motion picture (image) to the wireless terminal device 10. The wireless terminal device 10 is a device such as to display the motion picture (image), which has been received from the portable wireless terminal 20, in a realtime manner. The case where these instruments conduct P2P communication will be described by way of example. To be more specific, the present embodiment is suitable for systems in which, while watching the monitor of the wireless terminal device 10, the operator modifies the orientation, position, and the like of the CCD sensor included in the portable wireless terminal 20, to thereby freely observe various parts of something.

The present embodiment is also effective in the case where the wireless communication system includes a plurality of wireless terminal devices 10 and portable wireless terminals 20, and the P2P communication pairs between the wireless terminal devices 10 and the portable wireless terminals 20 are frequently changed. Presumable examples in which the P2P communication pairs are required to be frequently changed include the following case. There are a plurality of portable wireless terminals 20 with a CCD sensor that have been used so far. One of them is brought to another room for washing, maintenance, or the like. Then, another portable wireless terminal 20, which is subjected to washing or maintenance in advance, is utilized to wirelessly communicate with the wireless terminal device 10.

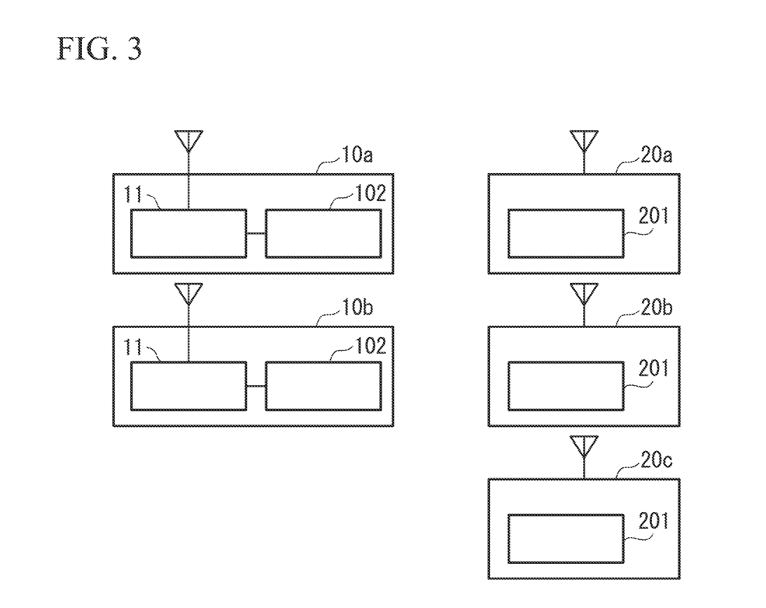

Next, workings of the present embodiment related especially to operations of the communication setting portion 104 of the wireless terminal device 10 and the terminal communication setting portion 203 of the portable wireless terminal 20 will be described with reference to FIG. 3. FIG. 3 is a schematic diagram showing the wireless terminal device 10 and portable wireless terminals 20 included in the wireless communication system of the present embodiment. In the illustration, the wireless communication system includes: wireless terminal devices 10a, 10b; and portable wireless terminals 20a to 20c.

Hereunder is a description of an operation for the case where, of the instruments included in the wireless communication system, the wireless terminal device 10a and the portable wireless terminal 20c are used in combination. Firstly, the operator sets the portable wireless terminal 20c onto a contactless power transmission portion 102 of the fixed wireless terminal 10a. On detecting that the portable wireless terminal 20c is set onto the contactless power transmission portion 102 of the wireless terminal device 10a, a communication setting portion 104 of the wireless terminal device 10a and a terminal communication setting portion 203 of the portable wireless terminal 20c use the second wireless communication line to exchange their individual user identification data (UID). The user identification data is information that uniquely identifies the wireless terminal device 10 or the portable wireless terminal 20.

The communication setting portion 104 and the terminal communication setting portion 203 switch their target devices to which their main information is transmitted (connection targets of P2P communication) to the devices that are uniquely identified by the pieces of user identification data they have exchanged.

This operation is a rewriting operation, in which the communication setting portion 104 and the terminal communication setting portion 203 delete the user identification data stored in a storage portion 103 and a terminal storage portion 204. At the same time, the communication setting portion 104 and the terminal communication setting portion 203 cause the storage portion 103 and the terminal storage portion 204 to store the newly-received user identification data. If the communication setting portion 104 and the terminal communication setting portion 203 are programmed to operate in this manner, then in the specific example of transferring a motion picture (image) in a realtime manner, the operator can display the motion picture (image), which is picked up by the CCD sensor included in the portable wireless terminal 20c in front of the operator, on a monitor screen included in the wireless terminal device 10a also in front of the operator, only by setting the portable wireless terminal 20c onto the contactless power transmission portion 102 of the wireless terminal device 10a.

Furthermore, even while an operator is using the wireless terminal device 10a and the portable wireless terminal 20c, another operator can use the wireless terminal device 10c in parallel with the portable wireless terminal 20a or 20b. However, the communication between the wireless terminal device 10 and the portable wireless terminal 20 has an object to conduct P2P communication. Therefore, if a plurality of portable wireless terminals 20 are to have a single wireless terminal device 10, it is necessary to make and control arrangements such as allowing only the firstly-powered portable wireless terminal 20 to communicate with the wireless terminal device 10. However, a later-powered portable wireless terminal 20 may be given highest priority.

As a method in which the communication setting portion 104 of the wireless terminal device 10 and the terminal communication setting portion 203 of the portable wireless terminal 20 detect that the portable wireless terminal 20 has been set onto the contactless power transmission portion 102 of the wireless terminal device 10, representative examples as follows can be conceived. The best method may be selected according to the situation of the wireless communication system.

(1) A method of detecting that the portable wireless terminal 20 has been placed on the contactless power transmission portion 102 of the wireless terminal device 10 in the case where an electromotive voltage produced in the contactless power reception portion 201 of the portable wireless terminal 20 is detected via wireless power transmission. In this case, it is necessary to always keep the contactless power transmission portion 102 of the wireless terminal device 10 in operation. However, if a treatment such as keeping the voltage applied to the contactless power transmission portion 102 low or causing the contactless power transmission portion 102 to operate at intervals is used, it is possible to achieve electric power saving.

(2) A method of detecting that the portable wireless terminal 20 has been placed on the contactless power transmission portion 102 of the wireless terminal device 10 in the case where communication by use of the second communication line is conducted at regular intervals and the communication is successful.

(3) A method of detecting that the portable wireless terminal 20 has been placed on the contactless power transmission portion 102 of the wireless terminal device 10 based on a detection result from a sensor utilizing magnetism such as one made of magnets and a Hall effect sensor or from a sensor utilizing detection of light such as one made of an optical sensor and a photoreceptor device. In this case, it is necessary to install the sensor or the device in the contactless power transmission portion 102 or the portable wireless terminal 20.

(4) A method of detecting that the portable wireless terminal 20 has been placed on the contactless power transmission portion 102 of the wireless terminal device 10 in the case where dedicated contact points, which are provided each on the contactless power transmission portion 102 of the wireless terminal device 10 and on the portable wireless terminal 20, are brought into contact with each other.

The aforementioned methods in which the communication setting portion 104 of the wireless terminal device 10 and the terminal communication setting portion 203 of the portable wireless terminal 20 detect that the portable wireless terminal 20 has been placed on the contactless power transmission portion 102 of the wireless terminal device 10 may be applied to the first embodiment.

Furthermore, as described above, on detecting that the portable wireless terminal 20 has been placed on the contactless power transmission portion 102 of the wireless terminal device 10, the communication setting portion 104 of the wireless terminal device 10 and the terminal communication setting portion 203 of the portable wireless terminal 20 exchange their user identification data by use of the second wireless communication line, and then switch their communication targets of their main information to instruments uniquely identified respectively by their user identification data they have exchanged. As a result, a pair of information transmissions by the P2P communication can be set without troublesome inputs. The second wireless communication line is a wireless communication line for which a technique of superimposing data transmission signals on a contactless power transmission channel is used. Therefore, the second wireless communication line can be implemented without the necessity of installing individual antennae for close proximity wireless transmission. This makes a reduction in manufacturing costs and downsizing of the products possible.

In the aforementioned first embodiment and second embodiment, the description has been made for the case where the storage portion 103 of the wireless terminal device 10 stores setting information necessary for conducting communication by use of the first wireless communication line (the group ID and encryption key in the first embodiment, and the user identification data in the second embodiment) and where the setting information is transmitted from the wireless terminal device 10 to the portable wireless terminal 20 by use of the second wireless communication line, by way of example. However, the configuration is not limited to this. For example, the terminal storage portion 204 of the portable wireless terminal 20 may store setting information necessary for conducting communication by use of the first wireless communication line, and the setting information may be transmitted from portable wireless terminal 20 to the wireless terminal device 10 by use of the second wireless communication line.

While the first embodiment and second embodiment of the present invention have been described in detail with reference to the drawings, specific configurations are not limited to those of the embodiments. Designs and so on without departing from the spirit or scope of this invention are included. Accordingly, the invention is not to be considered as being limited by the foregoing description, and is only limited by the scope of the appended claims.

What is claimed is:

1. A portable wireless terminal, comprising:
a battery portion that accumulates electric power;
a terminal wireless data communication portion that wirelessly communicates information;
a terminal communication setting portion that sets predetermined setting information related to wireless communication by the terminal wireless data communication portion; and
a power reception antenna that receives electric power for recharging the battery portion in a contactless manner from an external terminal, the power reception antenna transmitting or receiving the setting information to or from the external terminal.

2. The portable wireless terminal according to claim 1,
wherein the power reception antenna transmits or receives, as the setting information, information necessary at a beginning of the wireless communication by the terminal wireless data communication portion.

3. The portable wireless terminal according to claim 1,
wherein the setting information is a user identification data or encryption data for the wireless communication.

4. The portable wireless terminal according to claim 1
wherein the power reception antenna transmits or receives the setting information during the recharging or the electric power reception.

5. A wireless terminal device comprising:
a wireless data communication portion that wirelessly communicates information;
a communication setting portion that sets predetermined setting information related to wireless communication by the wireless data communication portion; and
a power transmission antenna that transmits electric power in a contactless manner to an external terminal, the power transmission antenna transmitting or receiving the setting information to or from the external terminal.

6. The wireless terminal device according to claim 5,
wherein the power transmission antenna and the wireless data communication portion are arranged in separate housings.

7. A wireless communication system comprising:
a portable wireless terminal; and
a wireless terminal device,
wherein the portable wireless terminal comprises:
a battery portion that accumulates electric power;
a terminal wireless data communication portion that wirelessly communicates information;
a terminal communication setting portion that sets predetermined setting information related to wireless communication by the terminal wireless data communication portion; and
a power reception antenna that receives electric power for recharging the battery portion in a contactless manner from the wireless terminal device, the power reception antenna transmitting or receiving the setting information to or from the wireless terminal device, and
wherein the wireless terminal device comprises:
a wireless data communication portion that wirelessly communicates information;
a communication setting portion that sets predetermined setting information related to wireless communication by the wireless data communication portion; and
a power transmission antenna that transmits electric power in a contactless manner to the portable wireless terminal, the power transmission antenna transmitting or receiving the setting information to or from the portable wireless terminal.

8. The wireless communication system according to claim 7,
wherein the terminal communication setting portion limits the wireless terminal device with which the terminal wireless data communication portion wirelessly communicates with the wireless terminal device to or from which the power reception antenna transmits or receives the setting information.

9. The wireless communication system according to claim 7,
wherein the communication setting portion limits the portable wireless terminal with which the wireless data communication portion wirelessly communicates with the portable wireless terminal to or from which the power transmission antenna transmits or receives the setting information.

10. The wireless communication system according to claim 7,
wherein a coverage distance of a wireless communication line between the power transmission antenna and the power reception antenna is substantially equal to a distance that electric power is allowed to be transmitted in the contactless manner.
